(19) United States
(12) Patent Application Publication
(10) Pub. No.: US 2021/0056624 A1
(43) Pub. Date: Feb. 25, 2021

(54) SECURE COMMUNICATION FRAMEWORK FOR CRYPTO-EXCHANGE SERVICES USING ASYMMETRIC AND SYMMETRIC ENCRYPTION

(71) Applicant: Krishna Achuthan, Atlanta, GA (US)

(72) Inventor: Krishna Achuthan, Atlanta, GA (US)

(21) Appl. No.: 16/547,256

(22) Filed: Aug. 21, 2019

(51) Int. Cl. G06Q 40/04; H04L 9/06; H04L 9/08; G06Q 20/38; G06Q 20/06

(52) U.S. Cl. CPC G06Q 40/04; H04L 9/0631; H04L 9/0822; G06Q 2220/00; G06Q 20/3829; G06Q 20/065; H04L 9/0825

(57) ABSTRACT

A unique framework is used for securing services, its components, and the communication channels in a digital asset exchange. The security framework may encompass a combination of authentication, limited access between every participating services (e.g., actors, machines, and components), and a hybrid cryptographic communication channel using both asymmetric and symmetric encryption.

### PRIORITY

This application claims the benefit of U.S. Provisional Application No. 62/721,172, filed Aug. 22, 2018, which is hereby incorporated by reference as if submitted in its entirety.

### FIELD OF THE INVENTION

The present invention relates to a crypto-currency exchange platform, and, more particularly, a secure communication framework for crypto-exchange services.

### BACKGROUND

With the advance of technology and spread of Internet access, the world is becoming more connected and people have access to nearly any information they seek. The number of internet users has been growing exponentially. Today, over 3.8 billion people has internet access, which is over 50% of the world's population, and this number is expected to rise. Over the past 20 years, the creation and usage of websites has been expanding with widespread access to the internet. The number of websites totaled 1 million in 1997, then reached and maintained at a milestone of 1 billion since 2016.

Another growing trend in the digital world is the development of decentralized trust. Utilizing blockchain technology, payments and/or contracts may be performed by distributed consensus and recorded on a blockchain. A blockchain is simply a distributed ledger of all transactions with respect to payments and/or established contracts. Digital coins, such as Bitcoin (BTC) or Ether (ETH), are much more than a digital currency, but a network of trust that provides the basis for so much more than just currencies. Cryptocurrency, such as BTC or ETH, is a collection of concepts and technologies that form the basis of a digital money ecosystem. Units of currency, such as BTC or ETH, are used to store and transmit value among users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake).

Blockchain based crypto-currencies are highly immune to attacks owing to the strong encryptions used for securing the data. However, the same cannot be said about the systems and communication channels that store and transport the tokens, especially the encryption/decryption keys, resulting in frequent attacks and theft of crypto-currency tokens. Securing the systems like crypto-currency exchanges cannot be done by hiding the details of the security framework or through obfuscation. Instead, a robust security framework needs to be built in an open manner that stands up to expert reviews and peer scrutiny.

### SUMMARY OF THE INVENTION

In an embodiment of the present invention, a unique framework is used for securing services, its components, and the communication channels in a digital asset exchange. The security framework may encompass a combination of authentication, limited access between every participating services (e.g., actors, machines, and components), and a hybrid cryptographic communication channel using both asymmetric and symmetric encryption.

In another embodiment of the disclosed invention, the principle of least privilege (POLP) may be applied to all users on an exchange platform, including services, service components, users, and interfaces to external software systems, without compromising performance.

In yet another embodiment of the disclosed invention, a combination of asymmetric and symmetric encryption may be used for all messages between services, service components, user interfaces, and interfaces to external software systems.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a simplified functional block diagram of a computer system in accordance with the embodiments of the disclosed invention;

FIG. 2 is simplified example of a distributed ledger in accordance with at least one embodiment of the invention;

FIG. 3 is a block diagram depicting an example blockchain environment 300, illustrating a simplified example of how a distributed ledger, or blockchain may be distributed, or replicated, on a network;

FIG. 4 illustrates an exemplary system architecture overview in accordance with the disclosed invention;

FIG. 5 illustrates an exemplary process for encrypted communication between services/component in accordance with the disclosed invention;

FIG. 6 illustrates an exemplary diagram illustrating a service communication channel and access management in accordance with the disclosed invention; and

FIG. 7 illustrates an exemplary cryptographic framework in accordance with the disclosed invention implementing asymmetric and symmetric encryption.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

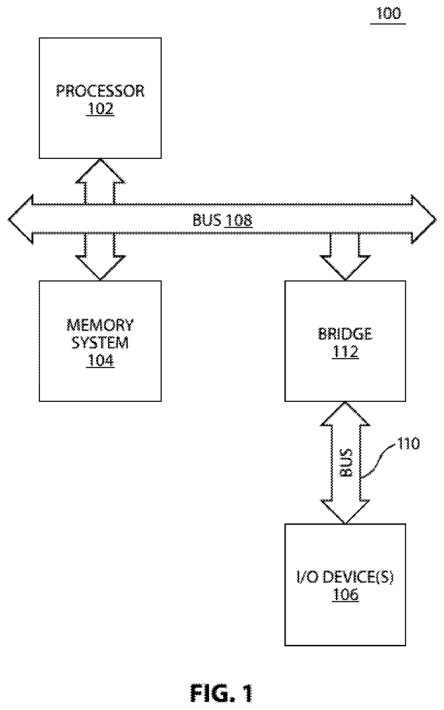

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can be implemented in a variety of ways and may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

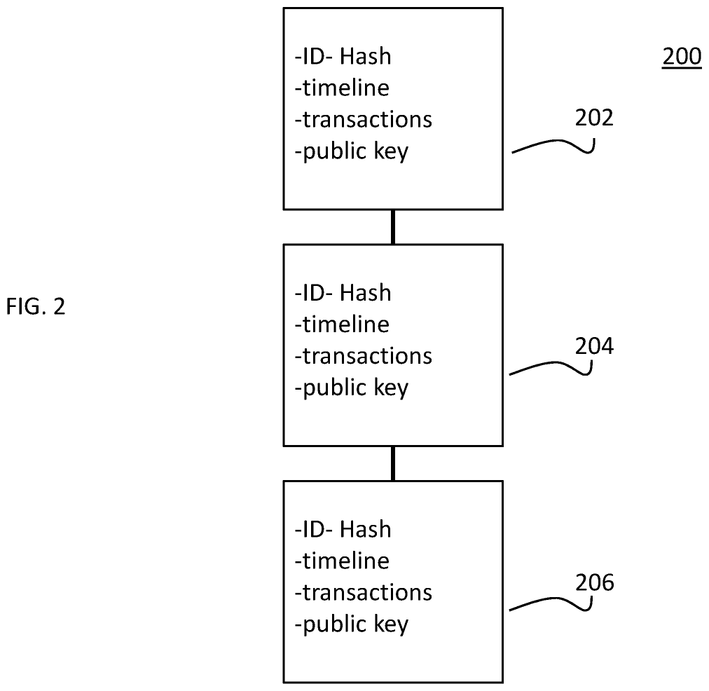

As illustrated in FIG. 2, blockchain 200 is an illustrative example in accordance with at least one embodiment of the invention. Blockchain 200 illustrates a simplified blockchain having 3 blocks, 202, 204, and 206. Block 202 is the first block and is therefore considered to be the genesis block. Each block may include certain information, such as an Identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. Hash values may be combined into a Merkle tree. The linked blocks therefore form a chain where each link, or block, in the chain uniquely identifies a previous link, or block, by including the hash or the prior link, or block.

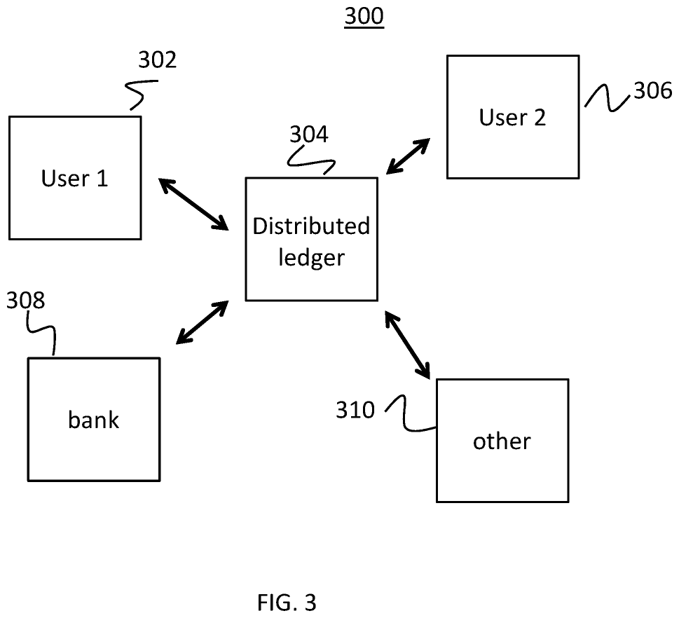

FIG. 3 is a block diagram depicting an example blockchain environment 300, illustrating a simplified example of how a distributed ledger, or blockchain (such as blockchain 200) may be distributed, or replicated, on a network. Environment 300 may include a first user 302, a second user 304, another entity, such as a bank 308, and another third party entity 310 privy to the blockchain 306. The first/second user may be a buyer or seller, based on the transaction. Entities may include, but are not limited to, consumers, bankers, merchants, and investors. Blockchain 306 may be replicated in an agreed-upon manner or in real-time (e.g., after each transaction).

In accordance with the present invention, and to ensure system security, the Principle of Least Privilege strategy may be employed for users, machines, and service components as described herein. Every participating entity with the framework, such as human actors (i.e. Admin personnel), and machines and services may be individually identified and assigned specific roles with limited to access to other participating entities. For example, when an entity, such as an Admin, is granted the right credentials, the Admin may start an exchange service only on machines specifically configured to start specific services. So, for example, if the Admin has the appropriate credentials to access a machine identified and configured to run only Service A, the machine cannot run other services like Service B or Service C.

Further, in accordance with the present invention, various services on an exchange, such as a crypto-currency exchange, may be controlled by a single administrative service. An administrative service would avoid the need or usage of startup scripts for individual services. Startup scripts for individual services are prone to vulnerabilities. An administrative service may pipe executable code into exchange hosts, start one or more individual services, and establish communication channels between services. Communication channels may be secured using encryption protocols, such as asymmetric encryption or RSA or the like. It is understood that the present invention is not limited to one or more security protocols.

Each service of the present invention may be pre-coded with access information to other services within an exchange framework. In the framework, an asymmetrically encrypted channel may be used for exchanging one or more symmetric encryption private keys. Services and their associated components may use symmetric encryption to send and receive messages with little impact to actual throughput. Services may also be limited in other ways to prevent attacks. Limitations may include, but certainly are not limited to, limiting a number of ports a service can use to communicate, limiting access to other participating service and a centralized logging service, and restricting access to operating system resources and limited to CPU, registry, and memory, for example.

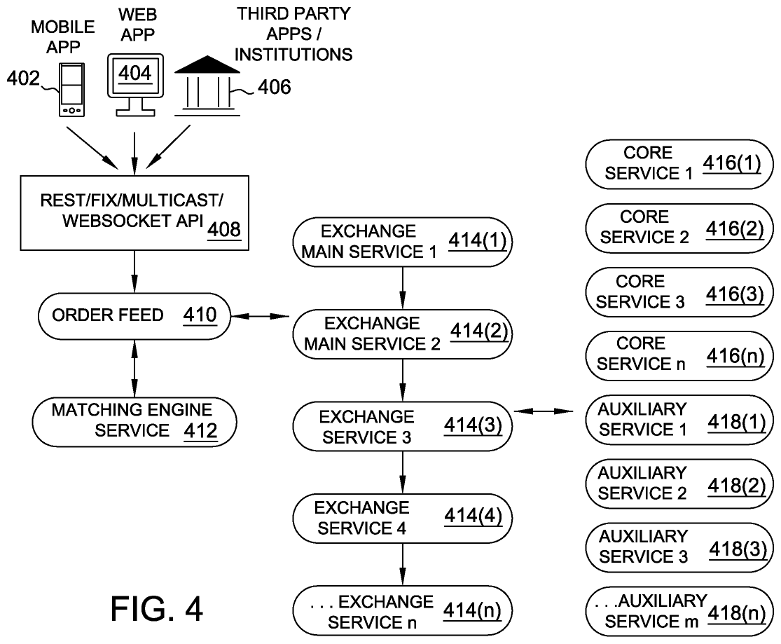

The present invention may be implemented by FIGS. 4-7, which have been provided merely as exemplary configurations and are not meant in any way to be limiting.

As shown in FIG. 4 an exemplary system architecture overview is illustrated in accordance with the disclosed invention. The system architecture may include a myriad of different end users that may access the system. For example, a mobile app 402, a web app 404, or a third party app 406. End users may access the system via an API 408 to submit transactions to be conducted. The API may be, for example, a REST API, a FIX, a Multicast, or a web socket API. From there, the API may interface with an order feed 410 which may be coupled to a matching engine service 412. As described herein, the order feed and matching engine service may work together in an administrative fashion to establish secure communication channels between service components required by an order generated by an end user. For example, the matching engine service may establish channels between any number of services, such as Exchange services 414(1)-414(n), core services 416(1)-416(n), and Auxiliary services 420(1)-420(m). In at least one embodiment, secure communication channels would only be established between service components required by a given transaction request.

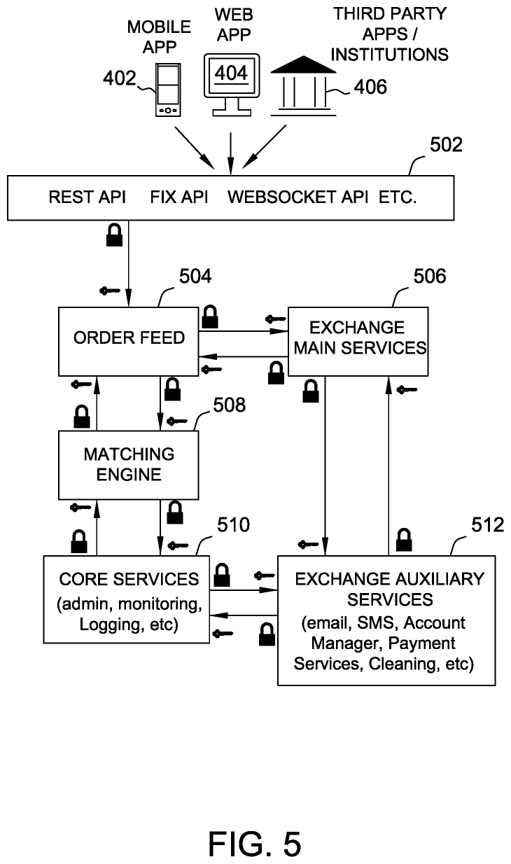

FIG. 5 illustrates another exemplary diagram for encrypted communication between services/component in accordance with the disclosed invention. Mobile App 402, Web App 404, and Third Party Apps 406 may transmit transaction requests to order feed 504 via API 502. API 502 may be a REST API, a FIX API, a WEBSOCKET API, or the like. Order feed 504, while in secure communication with Matching Engine 508, may facilitate the establishment of secure communication channels between service components based on the needs of transaction requests. Core Services 510 may include, but is not limited to, Administrative services, monitoring services, logging services, or the like. Exchange Auxiliary Services 512 may include email services, SMS services, account management services, payment services, clearing services, or the like. Exchange Main services 506 may be in direct communication with the Order Feed 504 and the Auxiliary services 512. The orientation of all components set forth by FIG. 5 is in no way meant to be limiting.

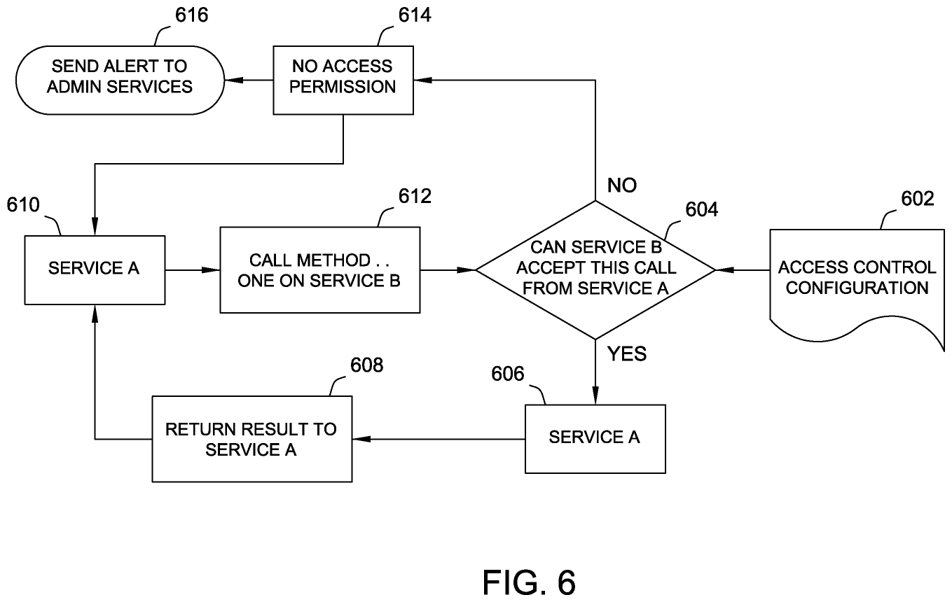

FIG. 6 illustrates an exemplary diagram illustrating a service communication channel and access management as described herein and above. Multiple services may exist, but for simplicity, the example given shows two services, Service A and Service B. Service A 610 may make a call 612 to Service B. A determination 604 is made using Access Control 602. If Access is denied, the process moves to 614. An alert 616 may then be transmitted to an appropriate entity, such as a network administrator or the like. If access is granted at 604, the service call is sent to Service B 606 and the result 608 is returned to Service A 610.

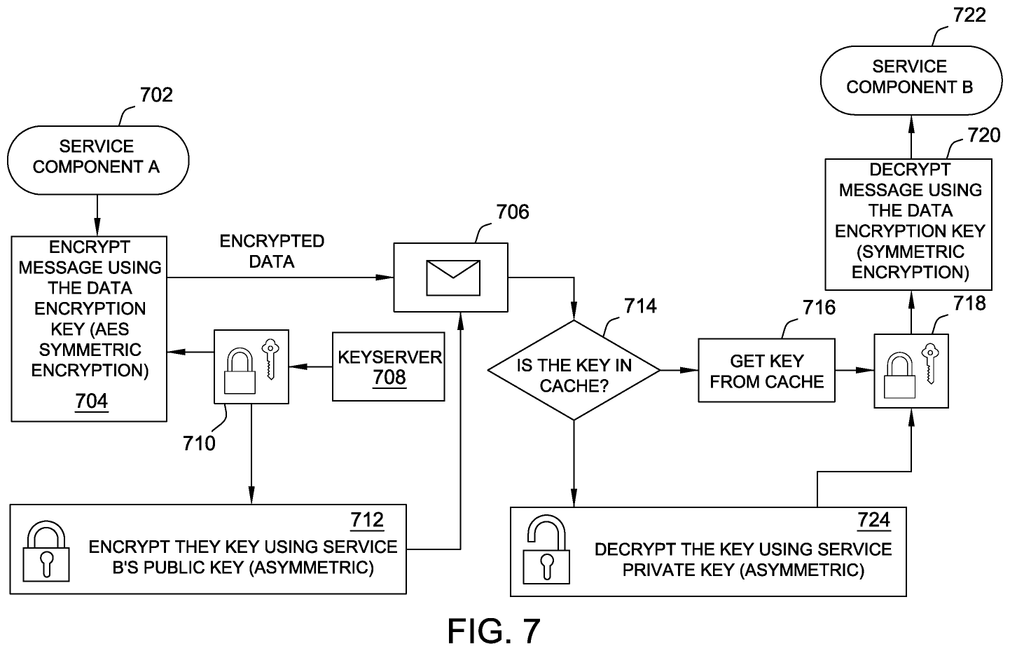

FIG. 7 shows an exemplary cryptographic framework in accordance with the disclosed invention implementing asymmetric and symmetric encryption. Similarly with respect to FIG. 6, multiple services may exist, but for simplicity, the example given provides two services, Service Component A 702 and Service Component B 722. In this example, a secure communication channel may be established between A and B. Service Component A 702 transmits a message. The message may be encrypted using a data encryption key (i.e. AES Symmetric Encryption). The data encryption key 710 may be provided by Keyserver 708. In step 712, the data encryption key may be encrypted using an asymmetric public key associated with Service Component B. The encrypted data, including the message and encrypted data encryption key may be transmitted 706 to Service Component B 722. Service Component B may then decrypt the data encryption key using their private key. If the key is in a cache 714, the key may be retrieved 716. If not in the cache 714, the data encryption key may be decrypted using Service Component B′s private key 724. At step 720, the message may be decrypted using the data encryption key and the process ends.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I/We claim:

1. A method for providing secure communication between service components, the method comprising:
sending, from a first service component, a message addressed to a second service component;
encrypting the message using a data encryption key;
encrypting the data encryption key;
sending the encrypted message and the encrypted data encryption key to the second service component;
receiving, at the second service component, the encrypted message and encrypted data encryption key;
decrypting the data encryption key using a private key; and
decrypting the message using the decrypted data encryption key.

2. The method of claim 1, wherein the data encryption key is provided by a key server.

3. The method of claim 2, wherein the message is encrypted using AES Symmetric Encryption.

4. The method of claim 3, wherein the data encryption key is encrypted using a public key associated with the second service component.

5. The method of claim 1, wherein the private key is obtained from a cache.

6. The method of claim 1, wherein the first and second service components are a subset of a plurality of service components.

7. The method of claim 6, wherein the plurality of service components are accessible via one or more of mobile applications, web applications, or third party applications.

8. A system for providing secure crypto-exchange services, the system comprising:
a plurality of end users;
a plurality of service components;
an API configured to provide one or more communication channels between the plurality of end users and the plurality of service components;
an order feed and a matching engine service configured to facilitate the one or more communication channels.

9. The system of claim 8, wherein the one or more communication channels are established between two or more of the plurality of service components by the matching engine service based on at least one order of the order feed.

10. The system of claim 9, wherein that at least one order is created by at least one of the plurality of end users.

11. The system of claim 8, wherein each of the plurality of service components is pre-coded with access information to each of the other plurality of service components.

12. The system of claim 9, wherein at least one of the one or more communication channels is asymmetrically encrypted.

13. The system of claim 12, wherein the at least one asymmetrically encrypted channel exchanges symmetrically encrypted private keys between two or more of the plurality of service components.

14. The system of claim 13, wherein the encrypted private key is encrypted by a keyserver.

15. The system of claim 14, wherein an encrypted data message is transmitted with the encrypted private key between two of the plurality of service components.

16. The system of claim 15, wherein the receiving one of the two of the plurality of service components decrypts the using a service private key and decrypts the message using the decrypted private key.

17. The system of claim 8, wherein the plurality of service components includes at least one or more of exchange services, core services, and auxiliary services.

18. A secure communication framework for crypto-exchange services, the framework configured to:
facilitate one or more communication channels configured to transport one or more blockchain-based crypto-currencies between endpoints;
limit access to one or more service components by the endpoints of the framework;
encrypt a message to be transported on the one or more communication channels using a data encryption key;
encrypt the data encryption key using an asymmetric public key;
transmit the encrypted message and the encrypted data encryption key via the one or more communication channels.

19. The secure communication framework of claim 18, wherein the framework is further configured to:
decrypt the data encryption key using an asymmetric private key.

20. The secure communication framework of claim 18, wherein the framework is further configured to:
decrypt the message using the decrypted data encryption key.
